(19) United States
(12) Patent Application Publication
(10) Pub. No.: US 2005/0071872 A1
(43) Pub. Date: Mar. 31, 2005

(54) Encoded video time-of-day information resolution and correction

(76) Inventor: Michael L. Case, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/676,419

(22) Filed: Sep. 30, 2003

(51) Int. Cl. H04N 7/173; G06F 13/00; H04N 5/445; H04N 7/16

(52) U.S. Cl. 725/50; 725/132; 725/140; 725/152

(57) ABSTRACT

Time-of-day information encoded into video signals can be managed to resolve conflicts and correct errors. In one embodiment, the invention includes receiving a plurality of video signals that include time-of-day information, evaluating the received signals for time-of-day information conflicts, extracting the time-of-day information from the video signals in accordance with the evaluation, determining a time-of-day using the extracted information in accordance with the evaluation, and setting a system clock based on the determined time of day. In another embodiment, the invention includes receiving a video stream, determining the source of the video stream, and modifying time-of-day information in the video stream based on the determined source.

### BACKGROUND

The present invention relates to the field of processing time-of-day information encoded into video signals and, in particular, to compensating for conflicts and errors in time-of-day information received from different video sources.

Many current televisions, personal video recorders (PVR), video tape recorders (VTR), audio/video receivers, media centers, and similar equipment incorporate clocks which are set using a signal from a programming broadcaster. The clock is used to display time of day, as well as for recording and tracking functions.

There are different types of broadcast clock signals. For current televisions, VTRs and PVRs, the most commonly used clock signal is in a type of XDS (Extended Data Services) packet. NTSC (National Television Standards Committee) television signals include a vertical blanking interval (VBI) between frames. This interval is used to broadcast many different kinds of information. If a broadcaster so chooses, line 21 of the VBI can be used to send XDS packets, in addition to closed caption data. XDS packets can provide the program name, program rating and transmission signal identifier. One type of XDS packet contains time-of-day and date information for the purpose of setting clocks in televisions and VTRs. Other broadcasting standards provide for other ways of transmitting the time-of-day or the date together with a video or audio broadcast.

If a receiver, whether in a television, VTR, PVR, media center or any other type of electronics device, can tune to two different broadcasts at the same time, then it may receive two different and possibly inconsistent time-of-day signals. This might occur as the receiver is displaying two pictures simultaneously on the same screen, e.g. picture in picture, or if it is recording one or two programs while displaying another. Even a device with a single tuner may receive inconsistent XDS packets or other time-of-day signals if the user is changing channels rapidly. These circumstances render the set clock time unreliable, or at least variable.

A further difficulty can occur for recorded programs. When a program is recorded, the time-of-day information is typically recorded too. Even if this information is accurate at the time that it was received it will relate to the time that the recorded signal was broadcast, not to the time that it is later being replayed. Later, when the program is replayed, the earlier time-of-day information will normally be reproduced as well. Any device that receives the replayed signal, might reset its time-of-day to the time in the replayed program. This can cause a discrepancy of minutes, weeks or months for programs that have been stored for viewing later. For a conventional PVR, all received video is first recorded onto a hard disk drive, then read from the drive for immediate, or delayed, display on a television monitor. The inherent delay in such a system can cause the PVR or television clock to be off by a few seconds or by a few minutes, if the time-of-day information is used.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 is a block diagram of a tuner module suitable for use with an embodiment of the present invention;

FIG. 2 is a signaling diagram for communications between a tuner microcontroller and a graphics system controller suitable for use with an embodiment of the present invention;

FIG. 3 is a block diagram of a media center suitable for implementing an embodiment of the present invention;

FIG. 4 is a block diagram of an entertainment system suitable for use with the present invention;

FIG. 5 is a generalized flow chart for setting a system clock using time-of-day information from several different video signals according to an embodiment of the present invention;

FIG. 6 is a flow chart for setting a system clock using a priority queue according to an embodiment of the present invention;

FIG. 7 is a flow chart for setting a system clock using averaging according to an embodiment of the present invention; and

FIG. 8 is a flow chart for setting a system clock using time-of-day information from several different video signals in which some signals may have been pre-recorded according to an embodiment of the present invention.

### DETAILED DESCRIPTION

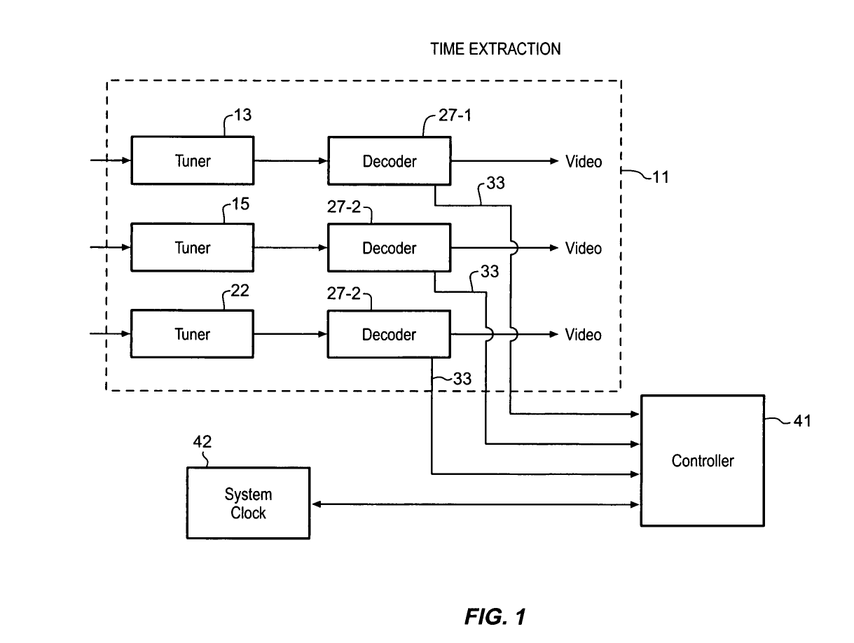

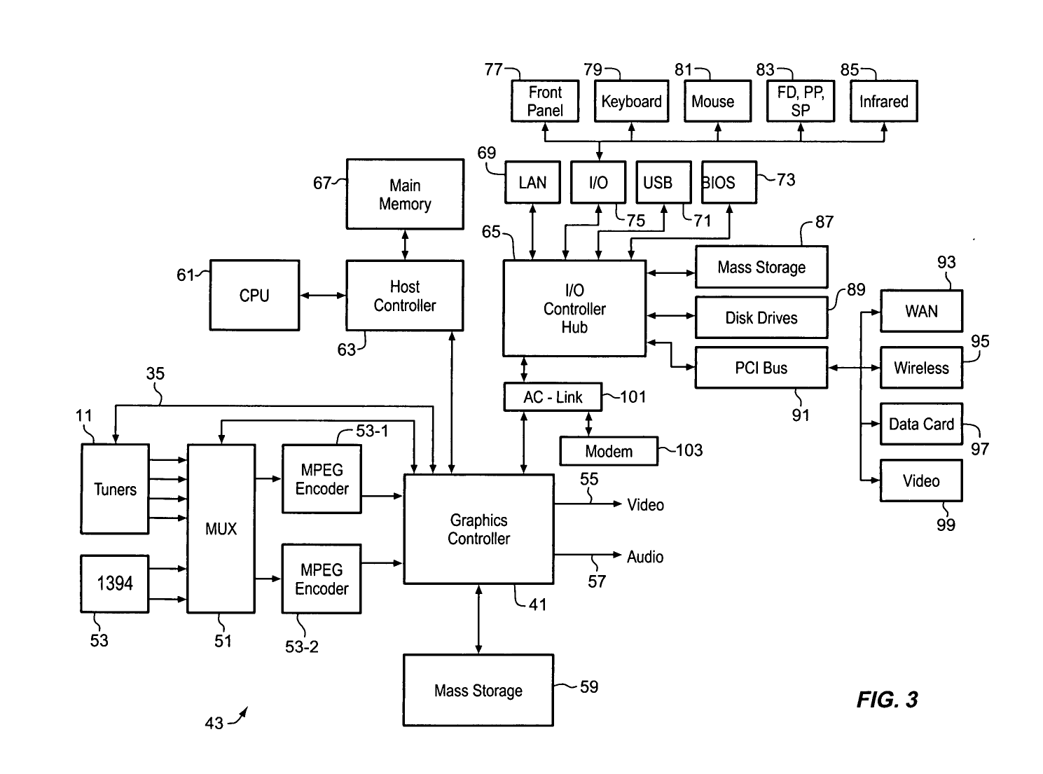

Referring to FIG. 1, a set of three tuners are grouped together. The group of tuners may be placed together on a single adapter card or printed circuit board, on a single module or wired together from disparate locations in a larger system. The tuners may also be configured in a self-contained module through the addition of power supply and other connections (not shown). The grouping may be coupled into a larger system, one example of which is the media center shown in FIG. 3. Such a system may be a television or video display, a video or audio recorder, a discrete tuner for connection to an entertainment system or any of a variety of other devices.

For purposes of the present description, the grouping of tuners and their decoders will be referred to herein as a tuner module 11. The tuner module has a variety of different tuners. The tuners shown and described are presented as examples, more or fewer or different tuners may be used. By constructing tuner modules with different sets of tuners, a single media center design, such as that shown in FIG. 3 or a design for another device may be outfitted for different locations, capabilities and price points.

The tuner module 11 of FIG. 1 has two video tuners 13, 15 these may be for any one of a variety of different digital television signals, whether broadcast, multicast or point-to-point. Examples include NTSC signals, ATSC (Advanced Television Systems Committee) signals, PAL (Phase Alternating Line) signals, cable television signals under the variety of possible standards, DBS (Direct Broadcast Satellite) signals, FM (Frequency Modulation) or AM (Amplitude Modulation) radio signals, satellite radio signals or any other type of video or audio signal. In the present example, the tuners are coupled to a television coaxial cable, a terrestrial broadcast antenna, or a satellite dish antenna and create an encoded signal for application to other components. The exact nature of the preferred output signal will depend on the particular device.

A composite video tuner is also shown. Such a device may allow the system to receive video and audio signals from a video recorder, camera, external tuner, or any other device. With a television monitor, the composite video tuner may allow the monitor to easily be switched from a digital cable broadcast to a home movie being played on a connected video camera. Picture-in-Picture and many other features may also be supported. A great variety of different connectors may be used for this tuner from coaxial cables to RCA component video, S-Video, DIN connectors, DVI (digital video interface), HDMI (High Definition Multimedia Interface), VGA (Video Graphics Adapter), and more.

The tuned signals are applied to decoders 27-1, 27-2, 27-3 to extract time-of-day information, if available. In one embodiment, the decoder digitizes all the data that is embedded in the VBI of the video signal. If the signal includes time-of-day information, then this will be included in the digitized VBI data. The decoder also produces video or audio output that may be transmitted directly to the larger system for recording or display.

Each of the decoders transmit the extracted time-of-day and other data through a data line 33 to a controller 41. The data line may also be used as a control line to allow the controller to send and receive messages to and from the decoders and the tuners. In one embodiment, the tuners are on a daisy-chained I²C (Inter-Integrated Circuit, a type of bus designed by Phillips Semiconductors to connect integrated circuits) control bus 33 which allows the controller to address each tuner individually at any time using assigned addresses, however, any other communications interface or protocol may be used. The controller may be designed with a unique device-specific interface for each tuner or it may operate through I/O interfaces with some or all of the tuners.

The graphics controller may be implemented using any of a variety of different processors or ASICs. Some examples include the ST Microelectronics® Sti70 15/20, the Zoran® TL8xx, or Generation 9, and the ATi® Technologies Xilleon™ lines of processors. The graphics controller may be the central processor for the larger system or coupled to a separate CPU, as shown in FIG. 3. The controller extracts the time-of-day information from each tuner that has received it, determines an appropriate time-of-day and sets the system clock 42 accordingly. The system clock may be a unique clock for video, recording, or display purposes or it may be the clock which controls all processes for the system. In one embodiment, the system clock is integrated on an I/O Host Controller (ICH) described below.

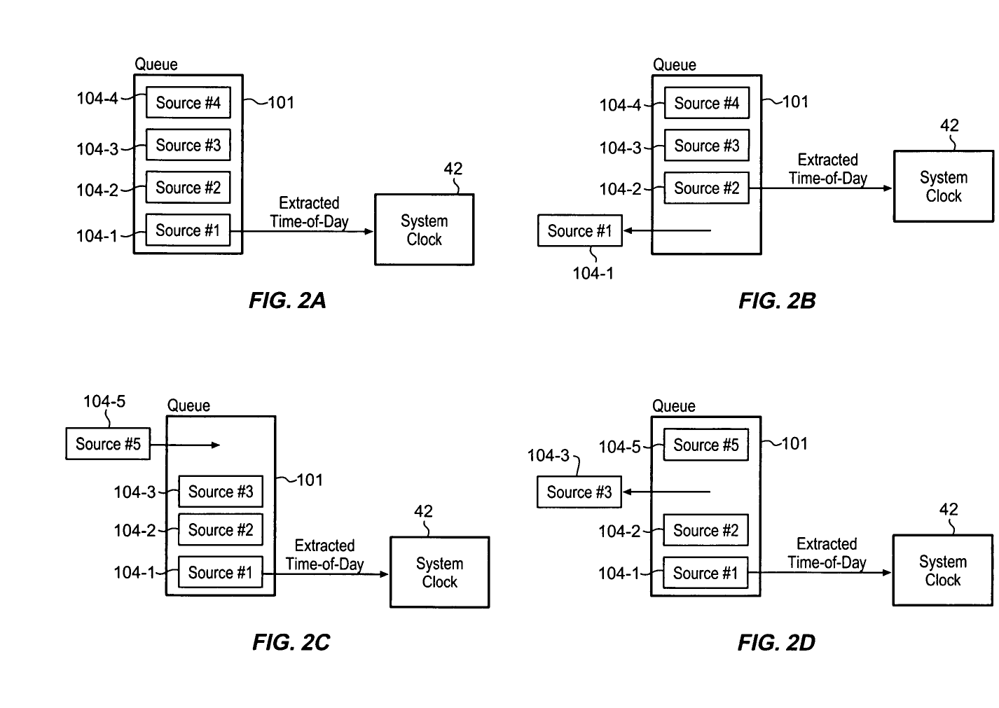

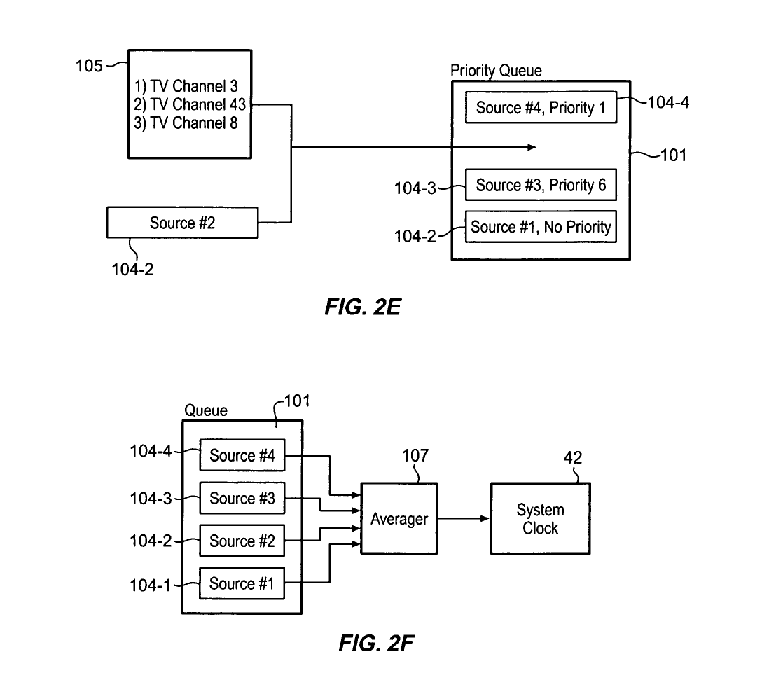

Referring to FIGS. 2A to 2F, a priority queue is shown that may be used to resolve differences in extracted time-of-day information. The priority queue may be maintained in the graphics controller, in a central processing unit for the larger system or in some other device or location. As shown in FIG. 2A, the priority queue 101 contains a list of the video signals that are currently available. In the example of FIG. 2A, four video signals are available 104-1, 104-2, 104-3, and 104-4. These may be from any of the tuners and other video sources shown, for example, in FIG. 1. The video signals are ranked in a priority order, shown in FIG. 2A as #1, #2, #3, and #4. The extracted time-of-day from video source number 1 is being used to set the system clock 42.

The priority queue is shown in FIGS. 2A to 2F in a simplified form, for ease of understanding. In a typical application, the priority queue may include much more or different information about each video source, for example, the tuner or source address, a designation of the channel or frequency, the type of signal and the type of time-of-day information. In some applications, video signals that do not include time-of-day information may also be included. In which case, the priority queue may contain information as to which of the video sources contain time-of-day information.

The ordering of the sources may be derived in any of a variety of different ways. In the example of FIG. 2A to 2D, the ordering is based on when the tuner for each source was activated. The video signal for source #1 became available first, so it as the highest order or priority. The video signal for source #2 became available second, for source #3 became available third and for source #4 became available fourth. This ordering is shown for purposes of illustration only and there are many different possible orderings depending on the behavior of the tuners or the user. This oldest to newest ordering may be obtained by assigning a start time to each source. When a source first becomes available, a system counter or the system clock or a number generator may assign some indication of the start time. The indication may be the actual time of day, however, because, the time is not important only the time relative to another source, the assigned indication may simply be a priority number. The indication for the source that has the second start time, for example might be a time of day, a counter value or simply the number 2. Such a start time indication may be used to maintain the ordering when the available channels change.

In FIG. 2B, source #1 has been deactivated. This may occur because the user has changed the channel, because a recording process has stopped or for any other reason. Since source #1 is no longer available, the clock synchronization switches to the next oldest source, the next channel in the priority queue, source #2. Source #2 is then used to set the system clock 42. In FIG. 2C, a new source, source #5 104-5, has become available. As the newest source, this source is added to the queue in the lowest position in the priority ordering. There is no change in the video signal that is used to set the system clock. This illustrates that using a time ordering for the priority queue, may enhance the stability of the clock.

In FIG. 2D, source #3 has become unavailable. It is removed from the queue, however, because it was not being used to set the system clock, there is no impact on the system clock. Anytime the source that is not currently the oldest is removed, the ordering of the currently available sources will change but the source being used to set the system clock will not change. The change in ordering may be performed with reference to the start time indicators associated with each source or video signal. The start time indicators, accordingly, may lend a higher level of stability to the system clock.

In FIG. 2E, a user preference list 105 is applied to the priority queue 101, to sort the currently available video signals into a priority order. The user preference list may be set by a user using screen displays and a user input by remote control or pointing device. A user may prefer to use a particular source for the system clock over some other source for many different reasons. For example, one source may be the primary source from which programs are recorded. One source may be known to have a clock that is consistently ahead of or behind or more accurate than the others. The user preference list may also begin as a factory default.

As shown in FIG. 2E, user preference list contains three possible video signal sources, TV Channel 3, TV Channel 43, and TV Channel 8, and they are ranked in that order. The user preference list may contain all or only some of the possibly available video signals in the ranking. Unranked channels may be handled in different ways. In one embodiment, unranked channels are ordered after ranked channels, the unranked channels are then ranked in some other order, such as by start time. In another embodiment, the unranked channels are not ordered, the time-of-day is averaged among them.

In FIG. 2E, sources #1, #3, and #4 are already in the queue. Source #2 is to be added, so it is referenced to the user preference list. In this example, source #2 corresponds to TV Channel 8. Source #4 corresponds to either TV Channel 3 or TV Channel 43, so it remains with the highest ranked priority, priority 1. Source #2 enters the queue with priority 2. Source #3 is indicated as priority 6. This ordering may derive from further user preferences not shown, from factory defaults, from a start time indication or from any of a variety of other grounds. Source #1 is indicated as having no priority. This may occur because it is not in the user preferences, because its start time was unknown, because it does not have time-of-day information or for many other reasons. As shown in FIG. 2E, the system clock is being set using source #4, before and after source #2 is added.

In FIG. 2F, the queue 101 also contains four sources 104-1, 104-2, 104-3, 104-4. These sources may or may not be ordered. The time-of-day information for all of the sources is being routed to an averager 107, which combines the information to set the system clock 42. The averager may combine the time-of-day information in a variety of different ways. For example, it may use an arithmetic mean, median or weighted average. It may also select or reject signals using statistical analysis such as standard deviations, distance from the median, etc. By using information from all of the video signals together, the system clock may be more stable. In addition, the impact of one signal being added or removed from the queue will be diminished.

FIG. 3 shows a block diagram of a media center 43 suitable for using the tuner module described above. In FIG. 3, the tuner module 11 is coupled to the graphics controller using e.g. an 12C interface as described above. The multiple video and audio outputs described with respect to FIG. 1 are coupled to a multiplexer 51. Other sources may also be coupled to the multiplexer, if desired, for example an IEEE 1394 appliance 53 is shown as also being coupled to the multiplexer. Some such devices might include, tape players, disk players and MP3 players, among others. The multiplexer, under control of the graphics controller selects which of the tuner or other inputs will be connected to the rest of the media center.

The selected tuner inputs are coupled to the multiplexer outputs. These multiplexer outputs are, in the present example, routed each to respective MPEG-2 encoders 53-1, 53-2 and then to the graphics controller 41. In the case of the digital television, radio, digital cable or satellite signals, the multiplexer may route the signals around the MPEG-2 encoders or disable the encoding process as these signals are already encoded.

From the graphics controller, the video and audio signals may be output for display, storage, or recording. In one embodiment, the graphics controller contains MPEG-2 and MPEG-3 decoders as well as a video signal processor to format video and audio signals for use by the desired appliance and to combine command, control, menu, messaging and other images with the video and audio from the tuners. The graphics controller may drive the entire device or operate only for graphics functions under control of another higher level processor, as described below.

For simplicity, FIG. 3 shows only one video output and one audio output, however, the number and variety of outputs may vary greatly depending on the particular application. If the media center is to function as a tuner, then a single DVI, or component video output, together with a single digital audio output, such as an optical S/PDIF (Sony/Philips Digital Interface) output, may suffice. In the configuration shown, the media center may be used as a tuner with picture-in-picture displays on a monitor or it may be used to record one channel while showing another. If the media center is to serve more functions then additional audio and video connections may be desired of one or more different types.

The actual connectors and formats for the video and audio connections may be of many different types and in different numbers. Some connector formats include coaxial cable, RCA composite video, S-Video, component video, DIN (Deutsche Industrie Norm) connectors, DVI (digital video interface), HDMI (High Definition Multimedia Interface), VGA (Video Graphics Adapter), and even USB and IEEE 1394. There are also several different proprietary connectors which may be preferred for particular applications. The types of connectors may be modified to suit a particular application or as different connectors become adopted.

The media center may also include a mass storage device, such as a hard disk drive, a volatile memory, a tape drive (e.g. for a VTR) or an optical drive. This may be used to store instructions for the graphics controller, to maintain an EPG (Electronic Program Guide) or to record audio or video received from the tuner module.

While the components described above are sufficient for many consumer electronics, home entertainment and home theater devices, such as tuners (terrestrial, cable, and satellite set-top boxes), VTR's, PVR's, and televisions, among others. Further functionality may be provided using some of the additional components described below. In addition, preamplifier and power amplifiers, control panels, or displays (not shown) may be coupled to the graphics controller as desired.

The media center may also include a CPU (Central Processing Unit) 61 coupled to a host controller 63 or chipset. Any number of different CPU's and chipsets may be used. In one embodiment a Mobile Intel® Celeron® processor with an Intel® 830 chipset is used, however the invention is not so limited. It offers more than sufficient processing power, connectivity and power saving modes. The host processor has a north bridge coupled to an I/O controller hub (ICH) 65, such as an Intel® FW82801D B (ICH4), and a south bridge coupled to on-board memory 67, such as RAM (Random Access Memory). The chipset also has an interface to couple with the graphics controller 41. Note that the invention is not limited to the particular choice of processor suggested herein.

The ICH 65 offers connectivity to a wide range of different devices. Well-established conventions and protocols may be used for these connections. The connections may include a LAN (Local Area Network) port 69, a USB hub 71, and a local BIOS (Basic Input/Output System) flash memory 73. A SIO (Super Input/Output) port 75 may provide connectivity for a front panel 77 with buttons and a display, a keyboard 79, a mouse 81, and infrared devices 85, such as IR blasters or remote control sensors. The I/O port may also support floppy disk, parallel port, and serial port connections. Alternatively, any one or more of these devices may be supported from a USB, PCI or any other type of bus.

The ICH may also provide an IDE (Integrated Device Electronics) bus for connections to disk drives 87, 89 or other large memory devices. The mass storage may include hard disk drives and optical drives. So, for example, software programs, user data, EPG data and recorded entertainment programming may be stored on a hard disk drive or other drive. In addition CD's (Compact Disk), DVD's (Digital Versatile Disk) and other storage media may be played on drives coupled to the IDE bus.

A PCI (Peripheral Component Interconnect) bus 91 is coupled to the ICH and allows a wide range of devices and ports to be coupled to the ICH. The examples in FIG. 3 include a WAN (Wide Area Network) port 93, a Wireless port 95, a data card connector 97, and a video adapter card 99. There are many more devices available for connection to a PCI port and many more possible functions. The PCI devices may allow for connections to local equipment, such as cameras, memory cards, telephones, PDA's (Personal Digital Assistant), or nearby computers. They may also allow for connection to various peripherals, such as printers, scanners, recorders, displays and more. They may also allow for wired or wireless connections to more remote equipment or any of a number of different interfaces. The remote equipment may allow for communication of programming or EPG data, for maintenance or remote control or for gaming, Internet surfing or other capabilities.

Finally, the ICH is shown with an AC-Link (Audio Codec Link) 101, a digital link that supports codecs with independent functions for audio and modem. In the audio section, microphone input and left and right audio channels are supported. In the example of FIG. 3, the AC-Link supports a modem 103 for connection to the PSTN, as well as an audio link to the graphics controller 41. The AC-Link carries any audio generated by the CPU, Host Controller or ICH to the graphics controller for integration with the audio output 57. Alternatively, an ISA (Industry Standard Architecture) bus, PCI bus or any other type connection may be used for this purpose. As can be seen from FIG. 3, there are many different ways to support the signals produced by the tuner and to control the operation of the tuners. The architecture of FIG. 3 allows for a wide range of different functions and capabilities. The particular design will depend on the particular application.

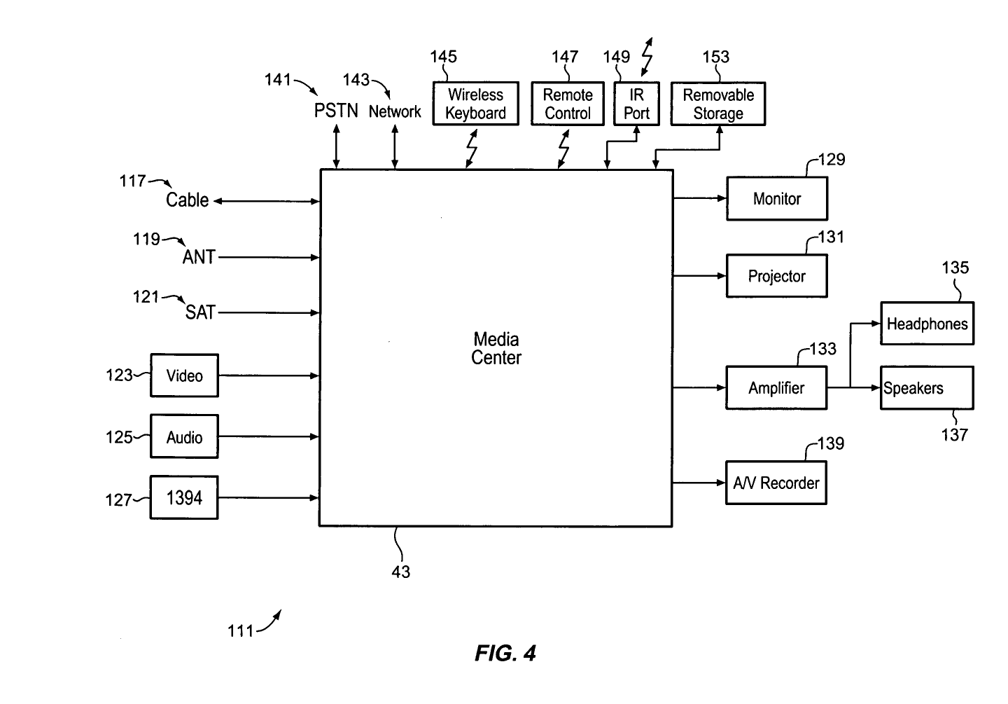

FIG. 4 shows a block diagram of an entertainment system 111 suitable for use with the media center of FIG. 3. FIG. 4 shows an entertainment system with a wide range of installed equipment. This equipment is shown as examples of many of the possibilities. The present invention may be used in a much simpler or still more complex system. The media center as described in FIG. 3, is able to support communication through WAN and LAN connections, Bluetooth, IEEE 802.11 USB, 1394, IDE, PCI, and Infrared. In addition, the tuner module receives inputs from antennas, component, and composite video and audio and IEEE 1394 devices. This provides extreme flexibility and variety in the types of devices that may be connected and operate with the media center. Other interfaces may be added or substituted for those described as new interfaces are developed and according to the particular application for the media center. Many of the connections may be removed to reduce cost. The specific devices, shown in FIG. 4 represent one example of a configuration that may be suitable for a consumer home entertainment system.

The media center 43 has several different possible inputs as described above. In the example of FIG. 4, these include a television cable 117, a broadcast antenna 119, a satellite receiver 121, a video player 123, such as a tape or disk player, an audio player 125, such as a tape, disk or memory player, and a digital device 127, connected for example by an IEEE 1394 connection.

These inputs, after processing, selection and control may be used to generate outputs for a user. The outputs may be rendered on a monitor 129, or projector 131, or any other kind of perceivable video display. The audio portion may be routed through an amplifier 133, such as an A/V receiver or a sound processing engine, to headphones 135, speakers 137 or any other type of sound generation device. The outputs may also be sent to an external recorder 139, such as a VTR, PVR, CD or DVD recorder, memory card etc.

The media center also provides connectivity to external devices through, for example a telephone port 141 and a network port 143. The user interface is provided through, for example, a keyboard 145, or a remote control 147 and the media center may communicate with other devices through its own infrared port 149. A removable storage device 153 may allow for MP3 compressed audio to be stored and played later on a portable device or for camera images to be displayed on the monitor 129.

There are many different equipment configurations for the entertainment center using the media center of FIG. 3 and many different possible choices of equipment to connect. A typical home entertainment system, using typical currently available equipment, might be as follows. As inputs, this typical home entertainment system might have a television antenna 119 and either a cable television 117 or DBS 121 input to the tuner module of the media center. A VTR or DVD recorder might be connected as an input device 123 and an output device 139. A CD player 125 and an MP3 player 127 might be added for music. Such a system might also include a wide screen high definition television 129, and a surround sound receiver 133 coupled to six or eight speakers 137. This same user system would have a small remote control 147 for the user and offer remote control 149 from the media center to the television, receiver, VTR, and CD player. An Internet connection 141 and keyboard 145 would allow for web surfing, upgrades and information downloads, while a computer network would allow for file swapping and remote control from or to a personal computer in the house.

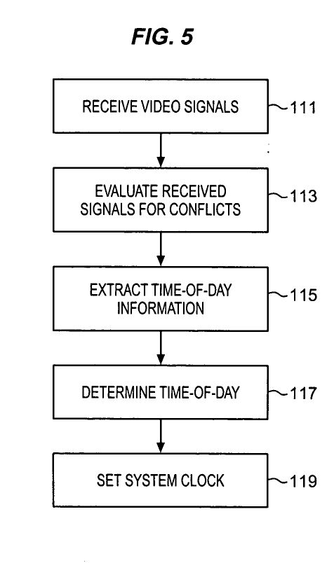

FIG. 5 is a generalized flow chart for setting a system clock using time-of-day information from several different video signals. The video signals are received in block 111. This may be done using the tuner module described with reference to FIG. 1 or in any other way. The received signals are evaluated for conflicts in block 113. Conflicts generally may arise because the time-of-day information comes from different sources. However, the evaluation may be performed in many different ways. This may include using a priority queue as described with reference to FIGS. 2A to 2D. The time-of-day information may be extracted before or after the conflicts are evaluated, depending on the particular implementation. This is shown in block 1115. Using the extracted time-of-day information a time-of-day is determined in block 117 and this is used to set the system clock in block 119. The time-of-day determination may be done in many different ways including, setting priorities, applying user preferences and averaging as described above.

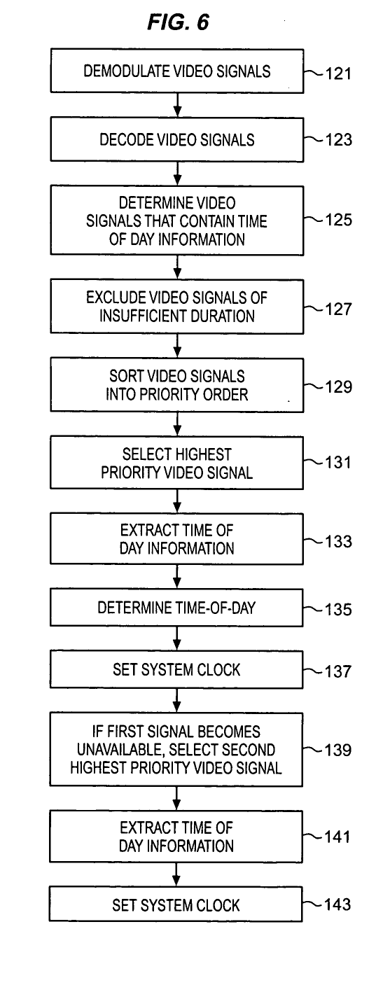

FIG. 6 shows a process flow for setting the system clock in more detail according to some embodiments of the invention. Video signals are first demodulated in block 121. The demodulated video signals are decoded in block 123. The decoding may be used to extract video portions and any other data that may be encoded into the video signal. For an NTSC signal, as described above, the decoding may extract all the VBI data, including closed caption text and XDS packets. For digital video signals, the data and video may also be decoded and separated into their respective constituent components. After the decoding, the video signals that contain time-of-day information may be determined in block 125.

In one embodiment, a decision methodology may be used in block 127 to exclude video signals of insufficient duration. The video signals may be excluded from the time-of-day setting process even if they are still used to display video on a screen. This exclusion of signals may be used to prevent rapid fluctuations in the system clock, especially when the user is changing channels rapidly, e.g. channel surfing. In one embodiment, the exclusion may be done by associating a timer with each new video signal. Only video signals that are available for more than some amount of time may be used to set the system clock. For example, the timer could be set so that only video signals that are available for more than seven minutes may be added to the queue. The specific amount of time may vary depending on a user preference, the type of video signal, or the nature of the programming. If a broadcaster typically uses commercial breaks of five minutes or less, then a seven minute threshold will prevent the system clock from being changed when the viewer changes channels only to avoid a commercials. If a broadcaster only places commercials at the beginning or end of an hour, then a clock may be used so that the system clock is not reset in the first or last five minutes of any hour. Different signal exclusion methodologies may be used for different applications.

As further shown in FIG. 6, the video signals are sorted into a priority order in block 129. As described above, this may be done in many different ways. One way is to apply a user-defined preference list to order the video signals. Another way is to assign an indication of a start time for each signal and order the signals using the assigned start time indications. As described above, the priority ordering may be managed using a priority queue, however, there are many other ways to associate the video signals with a priority. The complex queuing of FIGS. 2A to 2E are not necessary. The priority may indicate only which one is the highest priority. The next highest priority may be determined when and if the determination is necessary.

Once the signals are prioritized, the highest priority video signal is selected in block 131. The time-of-day information is extracted from the selected signal in block 133 and the time-of-day is determined in block 135. The time-of-day may be determined by reading the decoded time-of-day information in the video signal or there may be some adjusting, correcting or modifying performed on the time-of-day information before it is taken to be the correct time of day. The determined time-of-day is then used to set the system clock in block 137.

Video signals may come and go as tuned channels are changed or auxiliary equipment is connected and disconnected. If the selected highest priority video signal becomes unavailable, then the second highest priority video signal is selected in block 139. The time-of-day information is extracted from that signal in block 141, and the system clock is set in block 143 using the extracted time-of-day information.

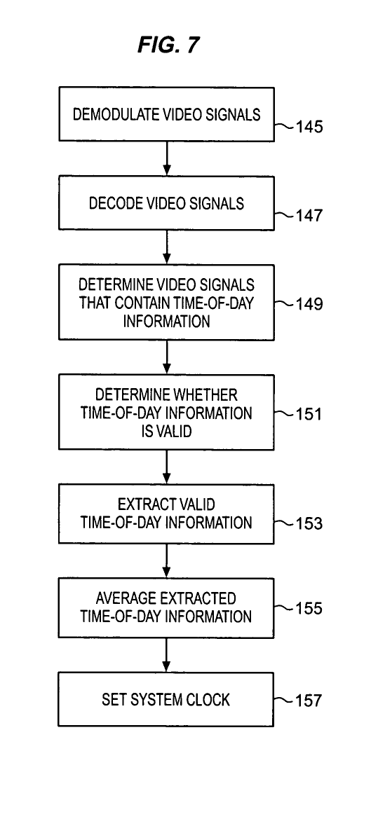

FIG. 7 shows a further alternative process flow for setting the system clock. Video signals are first demodulated in block 145. The demodulated video signals are decoded in block 147. After the decoding, the video signals that contain time-of-day information may be determined in block 149.

As described above, with respect to FIG. 6, some of the video signals may be excluded from the time-of-day process based on any number of different criteria. In addition, or as an alternative, one or more tests may be performed to determine whether the time-of-day information is valid for each video signal in block 151. The time-of-day information may be declared invalid, because it is corrupted, missing, from an unreliable source, from a time-delayed source, from a source that is not preferred, or from a source that has not been available for a sufficient amount of time. The video signals that do have valid time-of-day information may be placed in a priority queue, associated with an appropriate flag or marked in any other way. As an alternative it may be assumed that all video signals are valid and all time-of-day information may be used.

The valid time-of-day information is extracted from each identified video signal in block 153. The extracted time-of-day information is averaged in block 155, such as by taking an arithmetic mean or median. The average may be further processed using deviations, by excluding the minimum and maximum times, looking for saddle points etc. This value may then be used to set the system clock in block 157.

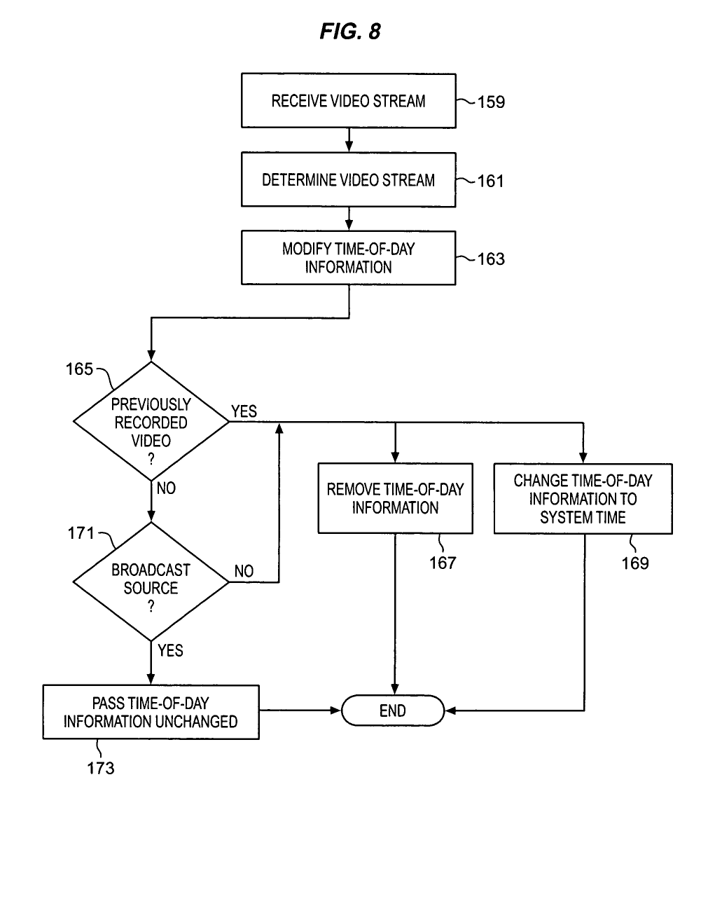

FIG. 8 shows a process flow that may be used to compensate for the impact of replaying previously recorded video. In FIG. 8, a video stream is received in block 159. The source of the video stream source is determined in block 161. This may be done by looking at any associated addresses, any headers in the video stream or by receiving some information about the video stream from a control process. If the video stream corresponds to a current broadcast, then its time-of-day information is likely to be correct. If, on the other hand, the video signal is from a recorder, then the time-of-day information may correspond to the time that the signal was recorded and not the current time. One way to determine whether the source is a prerecorded source is to compare the time-of-day information to the system clock. Time-of-day information that is significantly different from the system clock most likely comes from a prerecorded video signal.

The time-of-day information is modified in block 163. If the time-of-day information is inaccurate, either because of an inaccurate source or because the video signal was previously recorded, then the modification will result in a change to the video signal. This may be done by removing the time-of-day information or by changing the time-of-day information to the current time. In one embodiment, the system may check the time-of-day information against the system clock and change the time-of-day information to the system clock time. Any of these modifications will prevent the inaccurate time-of-day information in the video signal from upsetting the system clock in downstream hardware.

On the other hand, the time-of-day information may be passed to downstream hardware unchanged if the source of the video signal is a broadcast source with an accurate clock. The video stream may then be transmitted as required in block 165. For example, the video signal may be sent to a monitor which will show an accurate time. It may be sent to a recorder, which will show an accurate recording time or to any other entertainment system equipment or components.

It is to be appreciated that a lesser or more equipped entertainment system and media center than the example described above may be preferred for certain implementations. Therefore, the configuration of the entertainment system and media center will vary from implementation to implementation depending upon numerous factors, such as price constraints, performance requirements, technological improvements, or other circumstances. Embodiments of the invention may also be applied to other types of software-driven systems that use different hardware architectures than that shown in FIGS. 3 and 4.

In the description above, for purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various steps. The steps of the present invention may be performed by hardware components, such as those shown in FIGS. 1, 3, and 4, or may be embodied in machine-executable instructions, which may be used to cause general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program a media center (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods and apparatus are described in their most basic form but steps may be added to or deleted from any of the methods and components may be added or subtracted from any of the described apparatus without departing from the basic scope of the present invention. It will be apparent to those skilled in the art that many further modifications and adaptations may be made. The particular embodiments are not provided to limit the invention but to illustrate it. The scope of the present invention is not to be determined by the specific examples provided above but only by the claims below.

1. A method comprising:
receiving a plurality of video signals that include time-of-day information;
evaluating the received signals for time-of-day information conflicts;
extracting the time-of-day information from the video signals in accordance with the evaluation;
determining a time-of-day using the extracted information in accordance with the evaluation; and
setting a system clock based on the determined time of day.

2. The method of claim 1, wherein evaluating comprises selecting one of the video signals and wherein extracting comprises extracting the time-of-day information from the selected signal.

3. The method of claim 2, further comprising selecting a second one of the video signals, extracting the time-of-day information from the selected signal, and setting the system clock based on the second selected signal time of day, if the first selected signal becomes unavailable.

4. The method of claim 1, wherein evaluating comprises sorting the received video signals into a priority order and selecting the received video signal with highest priority and wherein extracting comprises extracting the time-of-day information from the selected signal.

5. The method of claim 4, wherein sorting comprises applying a user-defined preference list to the video signals and ordering the video signals using the user defined preferences.

6. The method of claim 4, wherein sorting comprises assigning an indication of a start time for each video signal and ordering the video signals using the assigned start time indications.

7. The method of claim 1, further comprising selecting another one of the video signals if the first selected video signal becomes unavailable.

8. The method of claim 7, wherein evaluating comprises sorting the decoded video signals into a priority order and selecting the video signal with highest priority and wherein selecting another one of the video signals comprises selecting the video signal with the next highest priority.

9. The method of claim 1, wherein determining a time-of-day comprises averaging values for the time-of-day indicated by the time-of-day information of at least two different video signals.

10. The method of claim 9, wherein evaluating comprises determining whether the time-of-day information of each of the plurality of video signals is valid.

11. The method of claim 1, wherein evaluating comprises determining a duration of the availability of each video signal and excluding video signals that have been available for an insufficient duration from determining the time of day.

12. The method of claim 1, wherein receiving comprises:
demodulating a plurality of video signals;
decoding the demodulated video signals;
analyzing the decoded video signals to determine the video signals that contain time-of-day information.

13. An article comprising a machine-readable medium having stored thereon data representing instructions which, when executed by a machine, cause the machine to perform operations comprising:
receiving a plurality of video signals that include time-of-day information;
evaluating the received signals for time-of-day information conflicts;
extracting the time-of-day information from the video signals in accordance with the evaluation;
determining a time-of-day using the extracted information in accordance with the evaluation; and
setting a system clock based on the determined time of day.

14. The article of claim 13, wherein evaluating comprises sorting the received video signals into a priority order and selecting the received video signal with highest priority and wherein extracting comprises extracting the time-of-day information from the selected signal.

15. The article of claim 14, wherein sorting comprises assigning an indication of a start time for each video signal and ordering the video signals using the assigned start time indications.

16. The method of claim 13, wherein determining a time-of-day comprises averaging values for the time-of-day indicated by the time-of-day information of at least two different video signals.

17. An apparatus comprising:
a plurality of tuners to receive video signals that include time-of-day information;
a plurality of decoders to extract the time-of-day information from the video signals; and
a processor to evaluate the received signals for time-of-day information conflicts, to determine a time-of-day using the extracted information in accordance with the evaluation, and to set a system clock based on the determined time of day.

18. The apparatus of claim 17, further comprising a priority queue in which the received video signals are in a priority order and wherein the processor determines a time-of-day by selecting the received video signal with highest priority in the queue.

19. The apparatus of claim 18, wherein the processor further sorts the received video signals into the priority queue by assigning an indication of a start time for each video signal and ordering the video signals using the assigned start time indications.

20. An apparatus comprising:
a plurality of tuners to receive wireless video signals modulated on a carrier frequency, the video signals including time-of-day information;
a plurality of decoders to extract the time-of-day information from the video signals; and
a processor to evaluate the received signals for time-of-day information conflicts, to determine a time-of-day using the extracted information in accordance with the evaluation, and to set a system clock based on the determined time of day.

21. The apparatus of claim 20, wherein the processor evaluates by selecting one of the video signals and wherein the processor extracts by extracting the time-of-day information from the selected signal, and wherein the processor selects a second one of the video signals, extracting the time-of-day information from the second signal, if the first selected signal becomes unavailable.

22. The apparatus of claim 20, wherein the processor evaluates the received video signals by applying a user-defined preference list.

23. The apparatus of claim 20, further comprising an averager to determine a time-of-day by averaging values for the time-of-day indicated by the time-of-day information of at least two different video signals.

24. A method comprising:
receiving a video stream;
determining the source of the video stream; and
modifying time-of-day information in the video stream based on the determined source.

25. The method of claim 24, wherein modifying comprises removing time-of-day information from the video stream if the source is previously recorded video.

26. The method of claim 24, wherein modifying comprises changing the time-of-day information to a current time if the source is previously recorded video.

27. The method of claim 24, wherein changing the time-of-day information to a current time comprises applying the time-of-day of a system clock.

28. The method of claim 24, wherein modifying comprises checking the time-of-day information against a system clock and changing the time-of-day information to the system clock time.

29. The method of claim 24, wherein modifying comprises passing the time-of-day information in the video stream unchanged if the source is a broadcast source.

30. An article comprising a machine-readable medium having stored thereon data representing instructions which, when executed by a machine, cause the machine to perform operations comprising:
receiving a video stream;
determining the source of the video stream; and
modifying time-of-day information in the video stream based on the determined source.

31. The article of claim 30, wherein modifying comprises removing time-of-day information from the video stream if the source is previously recorded video.

32. The article of claim 30, wherein modifying comprises checking the time-of-day information against a system clock and changing the time-of-day information to the system clock time.

33. An apparatus comprising:
a tuner to receive a video stream; and
a processor to determine the source of the video stream, and to modify time-of-day information in the video stream based on the determined source.

34. The apparatus of claim 30, wherein the processor modifies by removing time-of-day information from the video stream if the source is previously recorded video.

35. The apparatus of claim 30, wherein the processor modifies by changing the time-of-day information to a current time if the source is previously recorded video.

36. An apparatus comprising:
a tuner to receive a video stream from a video recorder; and
a processor to determine the source of the video stream, and to modify time-of-day information in the video stream based on the determined source.

37. The apparatus of claim 36, wherein the processor modifies by checking the time-of-day information against a system clock and changing the time-of-day information to the system clock time.

38. The apparatus of claim 36, wherein the processor modifies by removing time-of-day information from the video stream.
